(19) United States
(12) Patent Application Publication
(10) Pub. No.: US 2007/0201023 A1
(43) Pub. Date: Aug. 30, 2007

(54) Method for determining crystalline orientation using raman spectroscopy

(75) Inventor: Ming Li, Chelmsford, MA (US)

Correspondence Address: RATNERPRESTIA, P.O. BOX 980, VALLEY FORGE, PA, 19482, US

(73) Assignee: MATSUSHITA ELECTRIC INDUSTRIAL CO., LTD.

(21) Appl. No.: 11/710,284

(22) Filed: Feb. 23, 2007

Related U.S. Application Data
(60) Provisional application No. 60/776,521, filed on Feb. 24, 2006.

(51) Int. Cl. G01J 3/44; G01N 21/65

(52) U.S. Cl. 356/301; 356/31

(57) ABSTRACT

A method of determining the crystalline orientation of a crystal surface of a workpiece using Raman spectroscopy. A beam of substantially monochromatic light is directed to be incident on the crystal surface at a predetermined angle of incidence. The beam of light is substantially polarized. The workpiece is rotated relative to the beam of light about a rotation axis substantially normal to the crystal surface. A Raman shift of scattered light is measured at each of a number of rotational positions during the rotation of the workpiece. The crystalline orientation of the crystal surface is determined based on the measured Raman shifts. Data indicating the determined crystalline orientation of the crystal surface is stored.

### CROSS-REFERENCE TO RELATED APPLICATIONS

This application claims priority of U.S. Provisional Patent Application No. 60/776,521, filed Feb. 24, 2006, which is herein incorporated by reference.

### FIELD OF THE INVENTION

The present invention concerns methods for the determination of the crystalline orientation of crystals using Raman spectroscopy. In particular, these methods allow for the precision alignment of wafers of crystalline material for semiconductor processing.

### BACKGROUND OF THE INVENTION

Raman microprobe determination of crystal orientation is described, e.g., in J. Appl. Phys., Vol. 59, 1986, pp. 1103-1110 by J. B. Hopkins et al.

Referring to FIG. 6, there is schematically illustrated an arrangement of a principal portion in a conventional Raman microprobe apparatus for determining crystal orientation. An incident beam 1a of circularly polarized light is converted into a linearly polarized light beam 16 by a polarizer 7 which can be rotated. The linearly polarized light beam 1b is deflected by a half mirror 5 and then a light beam 1c thus deflected is focused on a specimen 4 by an object lens system 3.

Raman light scattered from the specimen 4 is collected as a Raman light beam 2a by the object lens system 3, a half of which is transmitted as a beam 2b through the half mirror 5 and then deflected as a beam 2c toward a polarization analyzer 8 by a complete mirror 6. A Raman light beam 2d having a particular polarization plane is selected from the beam 2c by the polarization analyzer 8.

The polarization-selected Raman light beam 2d is then introduced into a spectrometer (not shown) and then the Raman band of the specimen 4 is measured. In the conventional apparatus, the polarization intensity characteristic of the selected Raman light beam 2d is measured with either the polarizer 7 or polarization analyzer 8 being fixed and the other being rotated by a few degrees. The measured data of the polarization intensity characteristic are processed by a computer and compared with data derived theoretically as to known crystal orientation, whereby the crystal orientation of the specimen 4 can be determined.

In the conventional apparatus, however, it is difficult to make correction for measured data which contains experimental errors due to polarization plane shifts and light intensity distribution changes at the half mirror 5 and complete mirror 6.

In FIG. 6, linearly polarized light 1b having a particular polarization angle is selected by the polarization filter 7 from circularly polarized incident light 1a. This linearly polarized light 1b is reflected by the half mirror 5 and then slightly changes to linearly polarized light 1c having a polarization angle and intensity distribution both shifted slightly from those of the light 1b. As well known, the reason is that the reflectance of a mirror changes depending on the polarization angle of light. Because the Raman scattering is excited by the polarized light 1c, which is slightly different from the polarized light 1b, it is desirable to make correction as to an error in the measured data which is caused by the difference between the light 1b and the light 1c.

When Raman light 2a is transmitted through the half mirror 5, it also changes to light 2b having slightly different polarization components and slightly different intensity distribution. Further, when the light 2b is reflected by the complete mirror 6, it slightly changes to light 2c. A polarization angle and intensity distribution of linearly polarized light 2d selected from the light 2c are slightly different from those of the Raman light just as scattered from the specimen 4. Therefore, it is also desirable to make correction as to errors in the measured data which is caused by the polarization angle shifts and intensity distribution changes in the Raman light at the half mirror 5 and the complete mirror 6.

As described above, it is desirable in the conventional apparatus to make correction for the measured data as to the polarization shifts in both the incident light and Raman light. Because it is difficult to separate the errors in the obtained data due to the respective polarization shifts in the incident light and the Raman light, however, any such correction can only be an averaged correction. Therefore, some error still remains in the corrected data, and the accurate value can not be known.

Further, because the measurements are carried out with either the polarizer 7 or polarization analyzer 8 being rotated and the other being fixed in the conventional apparatus, not only the two optical parts of the polarizer and analyzer but also a parameter representing the analyzer relation between the polarizer and analyzer is indispensable.

Exemplary embodiments of the present invention include exemplary Raman spectroscopy methods that may be used to determine the crystalline orientation on a crystal surface of a workpiece.

### SUMMARY OF THE INVENTION

An exemplary embodiment of the present invention is a method of determining the crystalline orientation of a crystal surface of a workpiece using Raman spectroscopy. A beam of substantially monochromatic light is directed to be incident on the crystal surface at a predetermined angle of incidence. The beam of light is substantially polarized. The workpiece is rotated relative to the beam of light about a rotation axis substantially normal to the crystal surface. A Raman shift of scattered light is measured at each of a number of rotational positions during the rotation of the workpiece. The crystalline orientation of the crystal surface is determined based on the measured Raman shifts. Data indicating the determined crystalline orientation of the crystal surface is stored.

Another exemplary embodiment of the present invention is a method of determining the crystalline orientation of a crystal surface of a workpiece using Raman spectroscopy. A beam of substantially monochromatic light is directed to be incident on the crystal surface at an angle of incidence. The beam of light is substantially polarized. The angle of incidence between the beam of light and the crystal surface is varied. A Raman shift of scattered light is measured at each of a number of angles of incidence. The crystalline orientation of the crystal surface is determined based on the measured Raman shifts. Data indicating the determined crystalline orientation of the crystal surface is stored.

An additional exemplary embodiment of the present invention is a method of determining the crystalline orientation of a crystal surface of a workpiece using Raman spectroscopy. A beam of substantially monochromatic light is directed to be incident on the crystal surface at a predetermined angle of incidence. The beam of light is substantially linearly polarized. The polarization angle of the substantially linearly polarized beam of substantially monochromatic light is varied. Light scattered from the crystal surface is filtered such that the filtered light has a narrow bandwidth corresponding to the predetermined Raman peak of the crystal surface. The power of the filtered light is measured at each of a number of polarization angles. The crystalline orientation of the crystal surface is determined based on the measured power levels. Data indicating the determined crystalline orientation of the crystal surface is stored.

A further exemplary embodiment of the present invention is a method of determining the crystalline orientation of a crystal surface of a workpiece using Raman spectroscopy. A beam of substantially monochromatic light is directed to be incident on the crystal surface at a predetermined angle of incidence. The beam of light is substantially linearly polarized. The polarization angle of the substantially linearly polarized beam of substantially monochromatic light is varied. Scattered light at each of a number of polarization angles of the incident beam of light is detected. The detection is performed such that all polarizations of the scattered light are detected. A Raman shift of the detected light is measured at each of a number of polarization angles. The crystalline orientation of the crystal surface is determined based on the measured Raman shifts. Data indicating the determined crystalline orientation of the crystal surface is stored.

Yet another exemplary embodiment of the present invention is a method of determining a crystalline orientation of the top crystal surface of a workpiece that includes a crystal layer using Raman spectroscopy. The top crystal surface defines coordinate system in which the X-Y plane is parallel to the crystal surface and the Z axis is outwardly normal to the top crystal surface. A beam of substantially monochromatic and substantially polarized light is directed to be incident on a side surface of the crystal layer of the workpiece, such that the beam of light propagates substantially parallel to the X-Y plane at incidence. The workpiece is rotated about a rotation axis substantially parallel to the Z axis. A Raman shift of scattered light is measured at each of a number of rotational positions during the rotation of the workpiece. The crystalline orientation of the crystal surface is determined based on the measured Raman shifts. Data indicating the determined crystalline orientation of the crystal surface is stored.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a side plan drawing illustrating an exemplary Raman spectrometry system that may be used with exemplary methods according to the present invention.

FIG. 2 is a flowchart illustrating an exemplary Raman spectrometry method for determining crystalline orientation according to the present invention.

FIG. 3 is a flowchart illustrating an alternative exemplary Raman spectrometry method for determining crystalline orientation according to the present invention.

FIG. 4 is a flowchart illustrating another alternative exemplary Raman spectrometry method for determining crystalline orientation according to the present invention.

FIG. 5 is a flowchart illustrating a further alternative exemplary Raman spectrometry method for determining crystalline orientation according to the present invention.

FIG. 6 is a side plan drawing illustrating a prior art Raman spectrometry system.

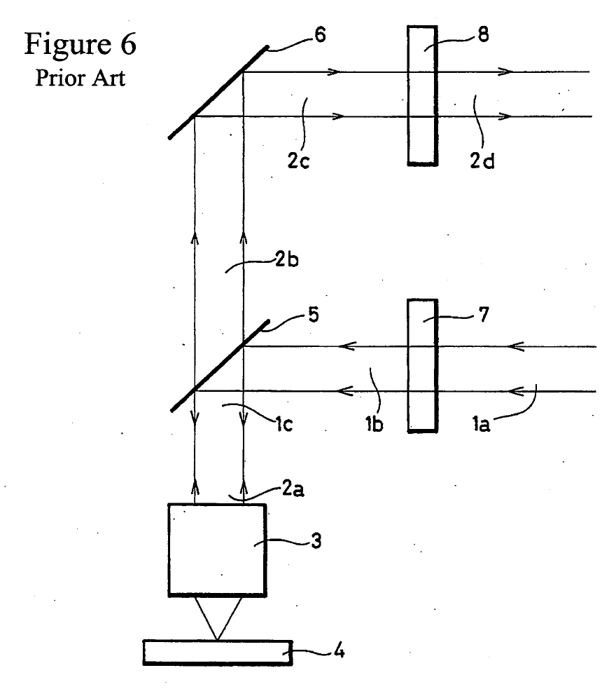

FIG. 7 is a top plan drawing illustrating exemplary coordinate axes that may be used to identify the orientation of a workpiece.

FIGS. 8A and 8B are schematic drawings illustrating exemplary propagation directions of light incident on a crystal layer in the exemplary method of FIG. 9.

FIG. 9 is a flowchart illustrating an additional exemplary Raman spectrometry method for determining crystalline orientation according to the present invention.

### DETAILED DESCRIPTION OF THE INVENTION

GaN, because of its excellent material characteristics, is anticipated to replace other materials, such as GaAs, in the manufacture of monolithic microwave integrated circuits (MMIC's). However, it is desirable in these applications to cleave larger, e.g. 2″ diameter, GaN wafers smaller pieces (7.2 mm×7.2 mm) before device fabrication. Identification of crystalline orientation is the first step in the cleaving process. Accurate identification of the crystalline orientation on crystal surfaces is also desirable in other materials and for other semiconductor fabrication processes. Wafer makers typically provide an orientation flat that is used to indicate crystalline orientation. Such flats may have an error of ±0.3° with respect to the actual crystalline orientation. These orientation flats, however, may not be accurate enough for some applications. For example, to obtain good cleaving, the tolerance is desirably about 0.03°.

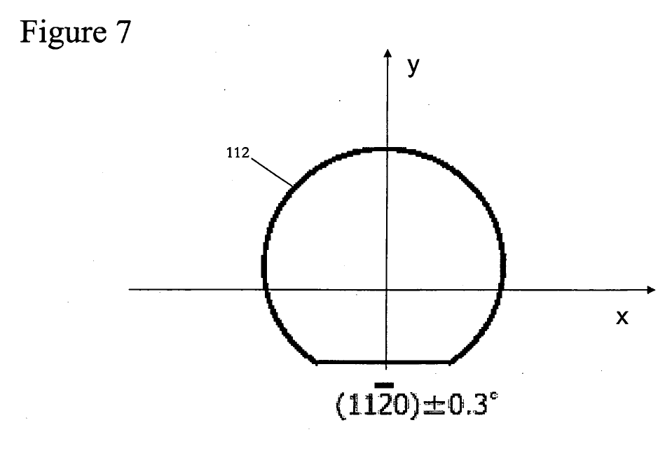

FIG. 7 illustrates exemplary coordinate axes that may be used to identify directions in exemplary embodiments of the present invention. As shown in FIG. 7, the top crystal surface of workpiece 112 may be used to define an X-Y plane. In this drawing, workpiece 112 is shown as a single crystal wafer with a wurzite crystalline structure. The X axis is parallel to the alignment flat, which is identified as being approximately parallel (±0.3°) with the (11 2̅0) face of the crystal. The positive Z axis is desirably aligned to be outwardly normal from this surface.

It is noted that it is particularly difficult to accurately determine the crystalline orientation of a crystal surface when the macroscopic properties of the surface are substantially isotropic. For such surfaces electro-optic and acousto-optic methods of determining the crystalline structure do not work well.

However, the lattice may be resolved using a probe that has a peak wavelength comparable to that of lattice constant, such as an X-ray probe. Although X-ray diffraction may be used to identify the crystalline orientation with the desired accuracy, this technique is performed in a vacuum, which may be impractical for mass-production. Therefore, a longer wavelength optical approach is desired.

Exemplary embodiments of the present invention involve exemplary Raman spectroscopy methods that may be used to determine the crystalline orientation on a crystal surface of a workpiece. This crystal surface may be the surface of a single crystal wafer or it may be the surface of a crystal layer grown on a substrate, e.g., a diamond layer grown on a silicon substrate. These exemplary techniques may be carried out in an ambient atmosphere and may attain the desired accuracy. Thus, they may allow for the simplified fabrication of improved semiconductor devices.

Raman scattering is an interaction between photons and lattice vibrations (phonons). The wavelength of photons or phonons (probes) is on the order of magnitude of that of lattice constant. Therefore, this is a microscopic approach. The photon energy of scattered light is equal to the photon energy of the incident light minus the phonon energy. The Raman shift is the difference in the scattered photon energy and the photon energy of incident light. Therefore, phonon energy is substantially equal to the Raman shift.

Coupling of the photon energy into the lattice depends on the polarization angle of the incident light with respect to lattice orientation and the angle of incidence of the incident light with respect to lattice orientation. Therefore, by varying the polarization angle and/or the angle of incidence of the incident light with respect of lattice, the Raman spectrum may be varied. With proper calibration, the lattice orientation may be resolved from these variations in the Raman spectra corresponding to different polarization angles and/or the angles of incidence of the incident light.

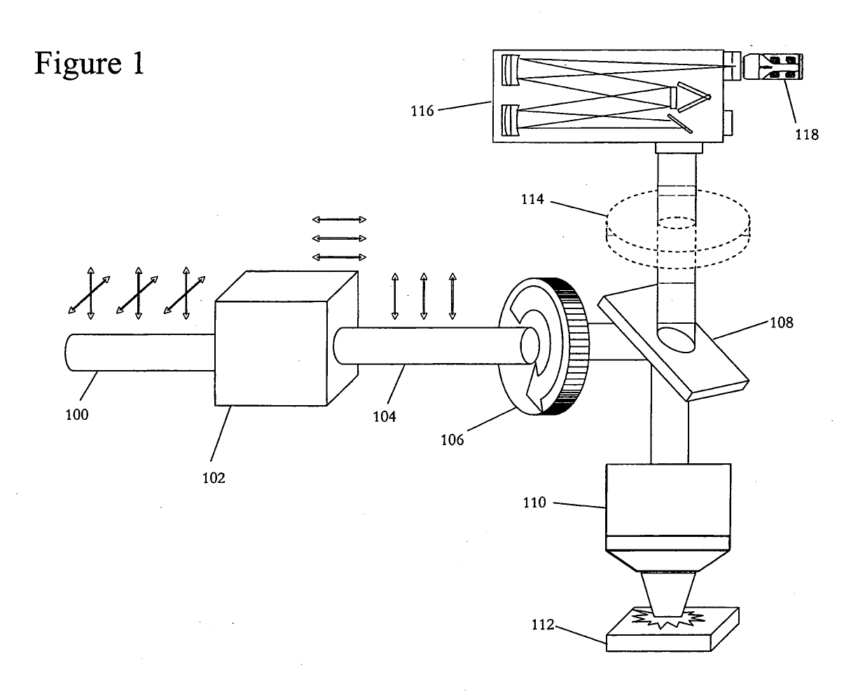

FIG. 1 illustrates an exemplary Raman spectroscopy system that may be used with some of the exemplary methods of the present invention. This exemplary system is merely illustrative and is not intended to be limiting. Further, one skilled in the art will understand simple alterations to this exemplary configuration that may be used to perform the remaining exemplary methods of the present invention.

In this exemplary system, light beam 100 is desirably substantially monochromatic, such as a laser light. It may be polarized; however this is not necessary. Light beam 100 is linearly polarized by polarizer 102 (shown as a polarizing beam splitter); unless it is already linearly polarized in which case polarizer 102 may be omitted. The polarization angle of linearly polarized light beam 104 may be rotated by half-wave plate 106. Alternatively, half-wave plate 106 may be omitted and workpiece 112 may be rotated instead.

The light beam is then reflected off of mirror 108. This mirror may desirably be dichromatic, i.e. highly reflective to the incident light and highly transmissive to the Raman shifted scattered light. Alternatively, mirror 108 may be a partially reflecting mirror. A partially reflecting mirror may be desirable if the scattered light has sufficient power. Objective 110 focuses the light beam onto the surface of workpiece 112 and collects scattered light. If there is sufficient scattered light this objective may be omitted.

At least a portion of the scattered light is transmitted through mirror 108. This light may be filtered by filter 114 before entering monochrometer 116. Filtering the scattered light may reduce the effects of any stray light, as may using monochrometer 116, so that only light corresponding to a peak of the Raman spectrum is detected by detector 118. Because of the potentially low power of the resulting narrow bandwidth light, detector 118 may be a photomultiplier tube, as shown in FIG. 1; however, it is contemplated that, in many of the exemplary embodiments of the present invention, the scattered light being detected may have sufficient power to be detected with other types of photodetectors.

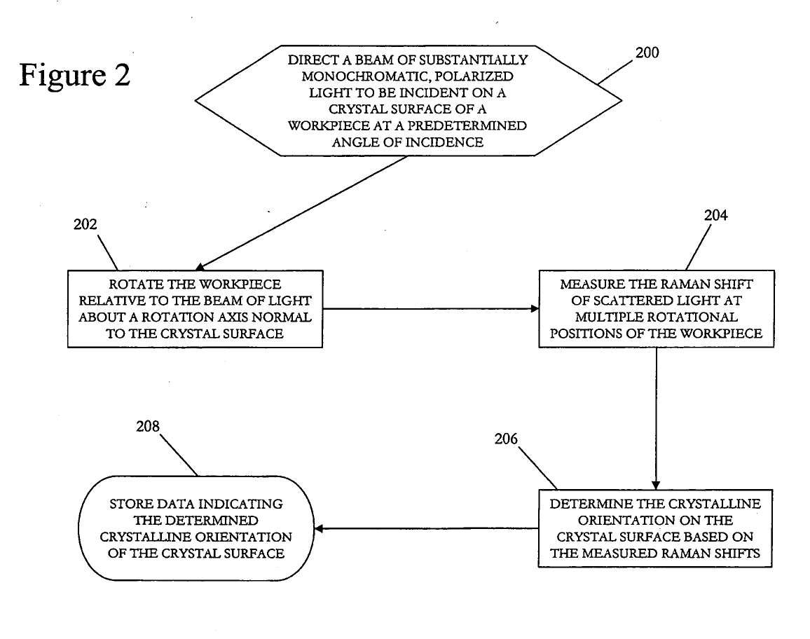

FIG. 2 illustrates an exemplary method of determining the crystalline orientation of a crystal surface of a workpiece using Raman spectroscopy. A beam of substantially monochromatic light is directed so that it is in incident on the crystal surface at a predetermined angle of incidence, step 200. To control the photon-phonon coupling and simplify the Raman spectrum, it is desirable for the beam of light to be polarized. If the predetermined angle of incidence is about 0°, then it is desirable for the beam of light to be substantially linearly polarized. However, if the predetermined angle of incidence is not about 0°, then the beam of light may be substantially linearly polarized or substantially circularly polarized.

The crystal surface is rotated relative to the beam of light about a rotation axis normal to the surface, step 202. The beam spot of the beam of light on the crystal surface is desirably approximately centered on the rotation axis so that substantially the same portion of the surface is illuminated throughout the measurements. Illuminating substantially the same portion of the surface throughout the measurements may reduce any artifacts in the scattered light due to defects or other inhomogeneities in the surface.

Scattered light from the surface is detected and a Raman shift of scattered light is measured at multiple rotational positions during the rotation of the workpiece, step 204. This measurement of the Raman shift may involve measuring full spectra of the scattered light (i.e. Raman spectra) at each of a number of predetermined rotational positions. Alternatively, it may involve filtering the scattered light such that the filtered light has a narrow bandwidth corresponding to a predetermined Raman peak of the crystal surface and then measuring the power of the filtered light at each of the predetermined rotational positions. It is noted that the light may be filtered so that the filtered light corresponds to more than one Raman peak of the crystal surface. The total power of this filtered light may be measured and/or the power of the light corresponding to each Raman peak may be measured separately.

The crystalline orientation of the crystal surface is then determined, step 206, based on the Raman shifts measured in step 204 and predetermined calibration data. The calibration data may be determined by comparing the Raman shifts of a reference crystal surface of the type being measured to its known crystalline orientation. This crystalline orientation of the reference crystal surface may be determined by X-ray crystallography, scanning probe microscopy (STM or AFM), or other methods known to one skilled in the art.

Data indicating the determined crystalline orientation of the crystal surface is stored, step 208. This data may be stored in temporary or permanent memory including, but not limited to, electronic memory such as a buffer or flash memory. The stored crystalline orientation may be used to mark the crystalline orientation on the workpiece. This marking may be done of the crystal surface or on another surface of the workpiece. Alternatively, the stored crystalline orientation data of the crystal surface may be used to determine the location of at least one cleavage plane through (or dicing street on the surface of) the workpiece. The workpiece may then be cleaved along the at least one cleavage plane (or diced along the at least one dicing street). The stored crystalline orientation data of the crystal surface may also be used for alignment purposes. For example, the stored crystalline orientation data of the crystal surface may be used to align: a photolithographic mask to the crystal surface; the scan line of a laser, or e-beam, writer on the crystal surface; or the tool path of a single-point micro-machining system on the crystal surface.

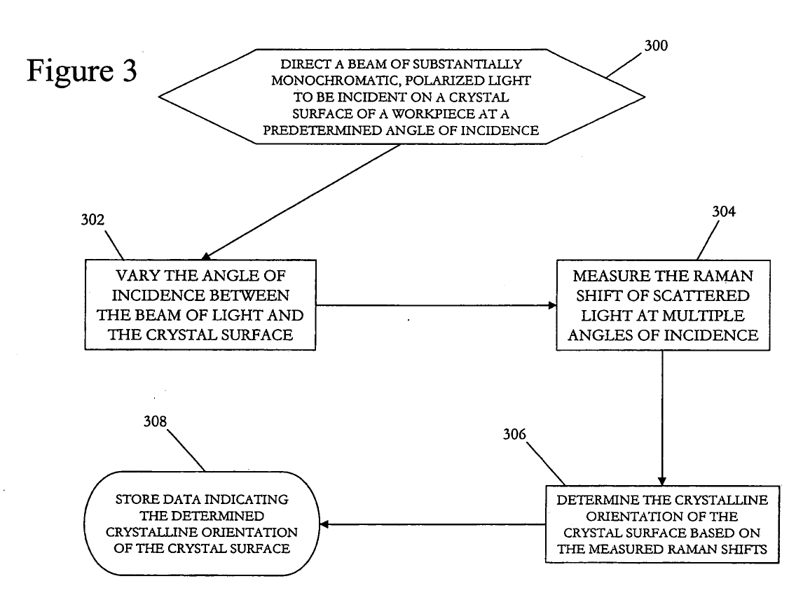

FIG. 3 illustrates another exemplary method of determining the crystalline orientation of a crystal surface of a workpiece using Raman spectroscopy according to the present invention. This exemplary method is similar to the exemplary method of FIG. 2. As in the exemplary method of FIG. 2, a beam of substantially monochromatic and substantially polarized light is directed to be incident on the crystal surface at a predetermined angle of incidence, step 300. The angle of incidence between the beam of light and the crystal surface is varied, step 302. This variation in the angle of incidence may be accomplished by changing the optical path of the beam of light, or by tilting the workpiece about an axis parallel to the surface being characterized.

The Raman shift of scattered light is measured at each of multiple angles of incidence, step 304. This measurement may be conducted using any of the exemplary techniques discussed above with reference to the exemplary method of FIG. 2.

The crystalline orientation of the crystal surface is then determined based on the measured Raman shifts, step 306, and data indicating the determined crystalline orientation of the crystal surface is stored, step 308.

As discussed above with reference to the exemplary method of FIG. 2, the stored data indicating the crystalline orientation of the crystal surface may be used for marking, cleaving, dicing, or aligning the workpiece among other procedures.

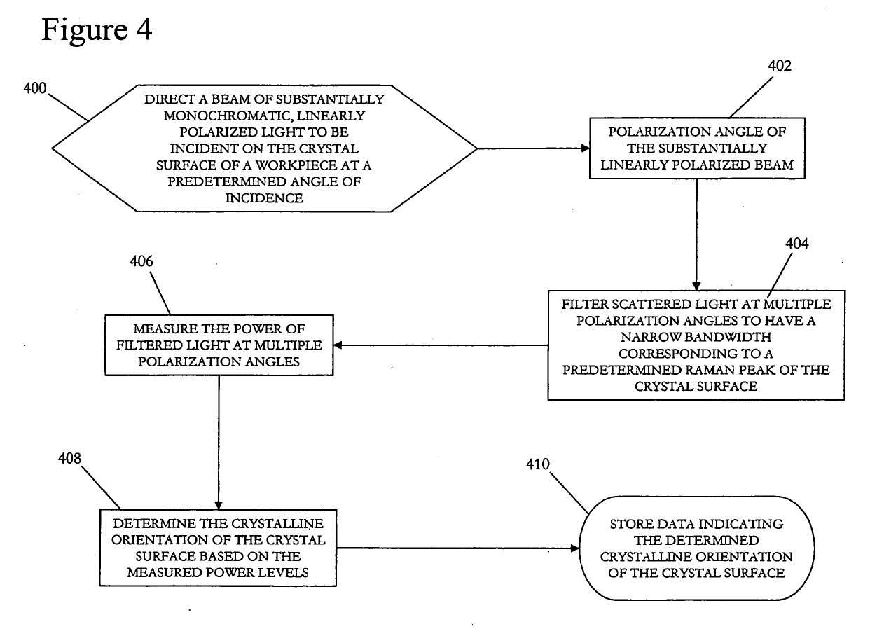

FIG. 4 illustrates a further exemplary method of determining the crystalline orientation of a crystal surface of a workpiece using Raman spectroscopy according to the present invention. This exemplary method is similar to the exemplary methods of FIGS. 2 and 3.

A beam of substantially monochromatic light is directed to be incident on the crystal surface at a predetermined angle of incidence, step 400. This beam of light is substantially linearly polarized. The predetermined angle of incidence may desirably be about 0°.

The polarization angle of the substantially linearly polarized beam of substantially monochromatic light is varied, step 402. This variation in the polarization angle may be accomplished using a half-wave plate place the optical path of the beam of light, as shown in the exemplary system of FIG. 1, or by rotating the workpiece about a rotational axis normal to the surface being characterized.

The scattered light is filtered at each of a plurality of polarization angles, step 404. The resulting filtered light has a narrow bandwidth corresponding to a predetermined Raman peak of the crystal surface. As discussed above with reference to the exemplary method of FIG. 2, it may be desirable to filter the scattered light such that a narrow band around each of several Raman peaks of the crystal surface are transmitted through the filter.

The power of the filtered light at each of a plurality of polarization angles to determine the Raman shift of the scattered light at that polarization angle, step 406. The crystalline orientation of the crystal surface is then determined based on the measured Raman shifts, step 408, and data indicating the determined crystalline orientation of the crystal surface is stored, step 410.

As discussed above with reference to the exemplary methods of FIGS. 2 and 3, the stored data indicating the crystalline orientation of the crystal surface may be used for marking, cleaving, dicing, or aligning the workpiece among other procedures.

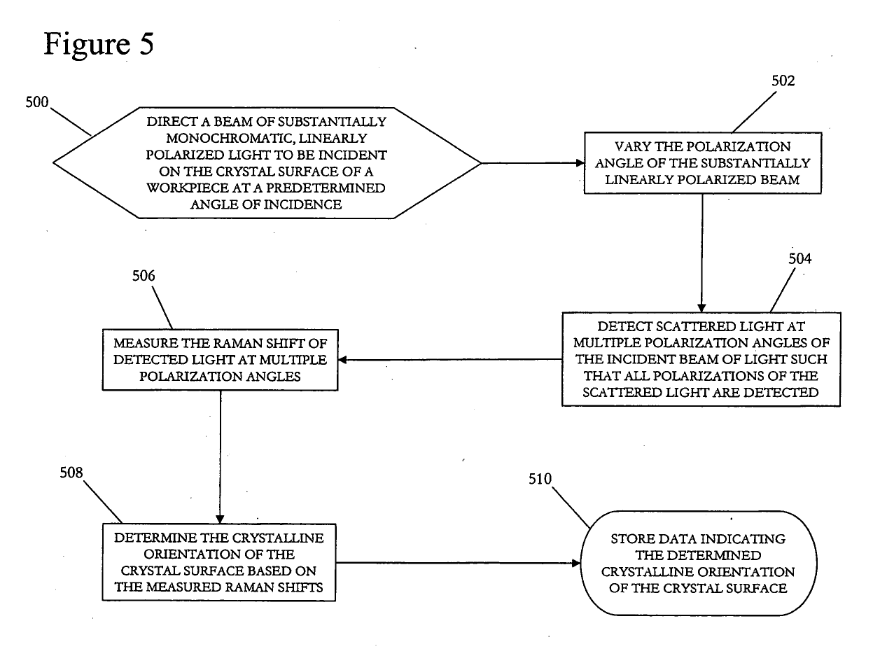

FIG. 5 illustrates an additional exemplary method of determining the crystalline orientation of a crystal surface of a workpiece using Raman spectroscopy according to the present invention. This exemplary method is similar to the exemplary methods of FIGS. 2, 3, and 4.

A beam of substantially monochromatic light is directed to be incident on the crystal surface at a predetermined angle of incidence, step 500. This beam of light is substantially linearly polarized. The predetermined angle of incidence may be about 0°.

The polarization angle of the substantially linearly polarized beam of substantially monochromatic light is varied, step 502. As in the exemplary method of FIG. 4, this variation in the polarization angle may be accomplished using a half-wave plate place the optical path of the beam of light, as shown in the exemplary system of FIG. 1, or by rotating the workpiece about a rotational axis normal to the surface being characterized.

The scattered light is detected at each of a plurality of polarization angles of the incident beam of light, step 504. This light is detected such that all polarizations of the scattered light are detected. The power of the detected light is measured at each of the polarization angles to determine the Raman shift of the scattered light at that polarization angle. The power detected may be the total power of the scattered light that is directed toward the detector, or the scattered light may be filtered as described above with reference to the exemplary methods of FIGS. 2 and 4.

The crystalline orientation of the crystal surface is then determined based on the measured Raman shifts, step 508, and data indicating the determined crystalline orientation of the crystal surface is stored, step 510.

As discussed above with reference to the exemplary methods of FIGS. 2, 3, and 4, the stored data indicating the crystalline orientation of the crystal surface may be used for marking, cleaving, dicing, or aligning the workpiece among other procedures.

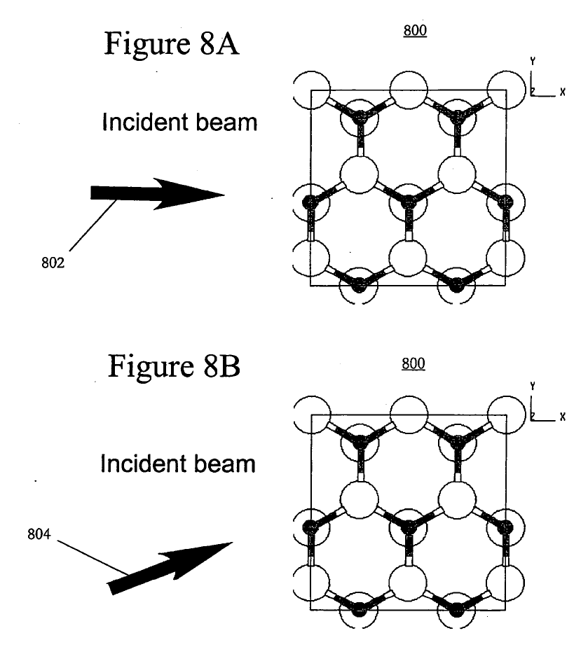

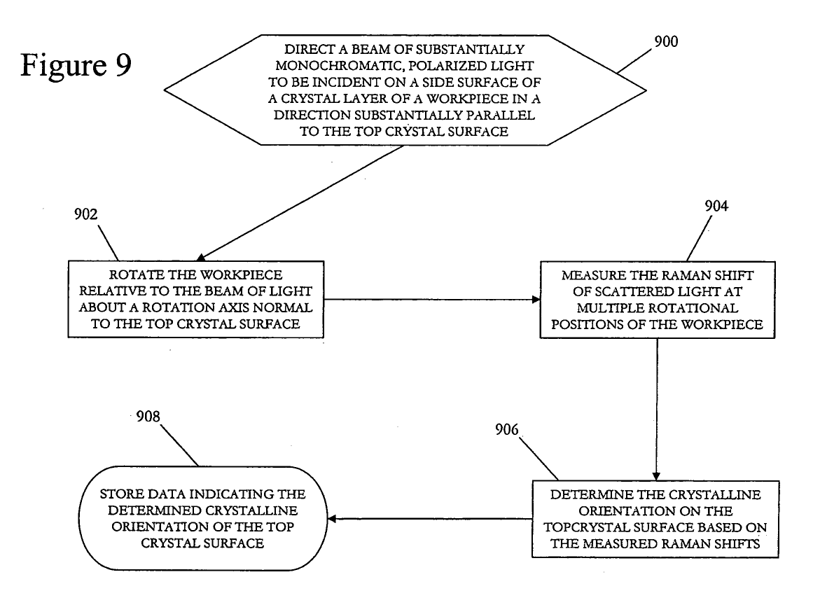

FIG. 9 illustrates an additional exemplary method of determining the crystalline orientation of a top crystal surface of a workpiece that includes a crystal layer, using Raman spectroscopy according to the present invention. As discussed above the crystal layer may be the entire workpiece or it may be a layer grown on a substrate of different material. In describing this exemplary method, it is convenient to utilize a coordinate axes, as illustrated above with reference to FIG. 7. The top crystal surface defines the X-Y plane (as shown in FIGS. 7, 8A, and 8B) and the Z axis is outwardly normal to the top crystal surface.

This exemplary method is similar to the exemplary methods of FIGS. 2 and 3. A beam of substantially monochromatic and substantially polarized light is directed to be incident on a side surface of the crystal layer, step 900. The direction of propagation of the beam is desirably substantially parallel to the X-Y plane at incidence. FIG. 8A illustrates beam 802 of substantially monochromatic and substantially polarized light incident on a side surface of crystal layer 800 (shown in a greatly enlarged, schematic representation). Although crystal layer 800 is shown in FIGS. 8A and 8B as having a wurzite structure (such as, e.g., GaN), this is only for illustrative purposes and is not intended to be limiting. One skilled in the art will understand that in this exemplary embodiment, however, it is desirable for the crystal layer to have a thickness greater than the peak wavelength of the incident light to allow efficient coupling of the incident light into the crystal layer.

The workpiece is rotated about a rotation axis substantially parallel to the Z axis, step 902. Light having different propagation directions, i.e. different momentum (k vectors), relative to the crystal lattice may lead to different Raman shifts (phonon energies). Therefore, varying the direction of propagation of an incident beam of substantially monochromatic and substantially polarized light in the X-Y plane from the direction shown in FIG. 8A (incident beam 802) to the direction shown in FIG. 8B (incident beam 804) may vary the resulting Raman shifts of the scattered light.

The Raman shift of scattered light is measured at each of multiple rotational positions during the rotation of the workpiece, step 904. This measurement may be conducted using any of the exemplary techniques discussed above with reference to the exemplary methods of FIGS. 2-5.

The crystalline orientation of the top crystal surface is then determined based on the measured Raman shifts, step 906, and data indicating the determined crystalline orientation of the top crystal surface is stored, step 908.

As discussed above with reference to the exemplary methods of FIGS. 2-5, the stored data indicating the crystalline orientation of the top crystal surface may be used for marking, cleaving, dicing, or aligning the workpiece among other procedures.

The present invention includes a number of exemplary methods for using Raman spectroscopy to determine the crystalline orientation of a crystal surface of a workpiece. Although the invention is illustrated and described herein with reference to specific embodiments, it is not intended to be limited to the details shown. Rather, various modifications may be made in the details within the scope and range of equivalents of the claims and without departing from the invention.

What is claimed:

1. A method of determining a crystalline orientation of a crystal surface of a workpiece using Raman spectroscopy, the method comprising the steps of:
a) directing a beam of substantially monochromatic light to be incident on the crystal surface at a predetermined angle of incidence, the beam of light being substantially polarized;
b) rotating the workpiece relative to the beam of light about a rotation axis substantially normal to the crystal surface;
c) measuring a Raman shift of scattered light at each of a plurality of rotational positions during the rotation of the workpiece;
d) determining the crystalline orientation of the crystal surface based on the plurality of Raman shifts measured in step (c); and
e) storing data indicating the determined crystalline orientation of the crystal surface.

2. A method according to claim 1, wherein the beam of light is one of substantially linearly polarized or substantially circularly polarized.

3. A method according to claim 1, wherein:
the beam of light is substantially linearly polarized; and
the predetermined angle of incidence is about 0°.

4. A method according to claim 1, wherein step (c) includes the steps of:
c1) filtering the scattered light such that the filtered light has a narrow bandwidth corresponding to a predetermined Raman peak of the crystal surface; and
c2) measuring a power of the filtered light at each of the plurality of rotational positions to determine the Raman shift of the scattered light at that rotational position.

5. A method according to claim 1, further comprising the step of:
f) marking the workpiece consistent with the stored crystalline orientation data.

6. A method according to claim 1, further comprising the step of:
f) using the stored crystalline orientation data of the crystal surface to determine a location of at least one cleavage plane through the workpiece; and
g) cleaving the workpiece along the at least one cleavage plane.

7. A method according to claim 1, further comprising the step of:
f) using the stored crystalline orientation data of the crystal surface to determine a location of at least one dicing street on the crystal surface; and
g) dicing the workpiece along the at least one dicing street.

8. A method according to claim 1, further comprising the step of:
f) using the stored crystalline orientation data of the crystal surface to align at least one of:
a photolithographic mask to the crystal surface;
a scan line of a laser writer on the crystal surface;
a scan line of an e-beam writer on the crystal surface; or
a tool path of a single-point micro-machining system on the crystal surface.

9. A method of determining a crystalline orientation of a crystal surface of a workpiece using Raman spectroscopy, the method comprising the steps of:
a) directing a beam of substantially monochromatic light to be incident on the crystal surface at an angle of incidence, the beam of light being substantially polarized;
b) varying the angle of incidence between the beam of light and the crystal surface;
c) measuring the Raman shift of scattered light at each of a plurality of angles of incidence;
d) determining the crystalline orientation of the crystal surface based on the plurality of Raman shifts measured in step (c); and
e) storing data indicating the determined crystalline orientation of the crystal surface.

10. A method according to claim 9, wherein the beam of light is one of substantially linearly polarized or substantially circularly polarized.

11. A method according to claim 9, wherein step (c) includes the steps of:
c1) filtering the scattered light such that the filtered light has a narrow bandwidth corresponding to a predetermined Raman peak of the crystal surface; and
c2) measuring a power of the filtered light at each of the plurality of angles of incidence to determine the corresponding Raman shift of the scattered light.

12. A method according to claim 9, further comprising the step of:
f) marking the workpiece consistent with the stored crystalline orientation data.

13. A method according to claim 9, further comprising the step of:
f) using the stored crystalline orientation data of the crystal surface to determine a location of at least one cleavage plane through the workpiece; and
g) cleaving the workpiece along the at least one cleavage plane.

14. A method according to claim 9, further comprising the step of:
f) using the stored crystalline orientation data of the crystal surface to determine a location of at least one dicing street on the crystal surface; and
g) dicing the workpiece along the at least one dicing street.

15. A method according to claim 9, further comprising the step of:
f) using the stored crystalline orientation data of the crystal surface to align at least one of:
a photolithographic mask to the crystal surface;
a scan line of a laser writer on the crystal surface;
a scan line of an e-beam writer on the crystal surface; or
a tool path of a single-point micro-machining system on the crystal surface.

16. A method of determining a crystalline orientation of a crystal surface of a workpiece using Raman spectroscopy, the method comprising the steps of:
a) directing a beam of substantially monochromatic light to be incident on the crystal surface at a predetermined angle of incidence, the beam of light being substantially linearly polarized;
b) varying a polarization angle of the substantially linearly polarized beam of substantially monochromatic light;
c) filtering light scattered from the crystal surface such that the filtered light has a narrow bandwidth corresponding to a predetermined Raman peak of the crystal surface;
d) measuring a power of the filtered light at each of a plurality of polarization angles;
e) determining the crystalline orientation of the crystal surface based on the plurality of power levels measured in step (d); and
f) storing data indicating the determined crystalline orientation of the crystal surface.

17. A method according to claim 16, wherein the predetermined angle of incidence is about 0°.

18. A method according to claim 16, further comprising the step of:
g) marking the workpiece consistent with the stored crystalline orientation data.

19. A method according to claim 16, further comprising the step of:
g) using the stored crystalline orientation data of the crystal surface to determine a location of at least one cleavage plane through the workpiece; and
h) cleaving the workpiece along the at least one cleavage plane.

20. A method according to claim 16, further comprising the step of:
g) using the stored crystalline orientation data of the crystal surface to determine a location of at least one dicing street on the crystal surface; and
h) dicing the workpiece along the at least one dicing street.

21. A method according to claim 16, further comprising the step of:
g) using the stored crystalline orientation data of the crystal surface to align at least one of:
a photolithographic mask to the crystal surface;
a scan line of a laser writer on the crystal surface;
a scan line of an e-beam writer on the crystal surface; or
a tool path of a single-point micro-machining system on the crystal surface.

22. A method of determining a crystalline orientation of a crystal surface of a workpiece using Raman spectroscopy, the method comprising the steps of:
a) directing a beam of substantially monochromatic light to be incident on the crystal surface at a predetermined angle of incidence, the beam of light being substantially linearly polarized;
b) varying a polarization angle of the substantially linearly polarized beam of substantially monochromatic light;
c) detecting scattered light at each of a plurality of polarization angles of the incident beam of light such that all polarizations of the scattered light are detected;
d) measuring a Raman shift of the detected light at each of the plurality of polarization angles;
e) determining the crystalline orientation of the crystal surface based on the plurality of Raman shifts measured in step (d); and
f) storing data indicating the determined crystalline orientation of the crystal surface.

23. A method according to claim 22, wherein the predetermined angle of incidence is about 0°.

24. A method according to claim 22, wherein step (d) includes the steps of:
d1) filtering the scattered light such that the filtered light has a narrow bandwidth corresponding to a predetermined Raman peak of the crystal surface; and
d2) measuring the power of the filtered light at each of the plurality of polarization angles to determine the Raman shift of the scattered light at that polarization angle.

25. A method according to claim 22, further comprising the step of:
g) marking the workpiece consistent with the stored crystalline orientation data.

26. A method according to claim 22, further comprising the step of:
g) using the stored crystalline orientation data of the crystal surface to determine a location of at least one cleavage plane through the workpiece; and
h) cleaving the workpiece along the at least one cleavage plane.

27. A method according to claim 22, further comprising the step of:
g) using the stored crystalline orientation data of the crystal surface to determine a location of at least one dicing street on the crystal surface; and
h) dicing the workpiece along the at least one dicing street.

28. A method according to claim 22, further comprising the step of:
g) using the stored crystalline orientation data of the crystal surface to align at least one of:
a photolithographic mask to the crystal surface;
a scan line of a laser writer on the crystal surface;
a scan line of an e-beam writer on the crystal surface; or
a tool path of a single-point micro-machining system on the crystal surface.

29. A method of determining a crystalline orientation of a top crystal surface of a workpiece that includes a crystal layer using Raman spectroscopy, the top crystal surface defining an X-Y plane, a Z axis being outwardly normal to the top crystal surface, the method comprising the steps of:
a) directing a beam of substantially monochromatic and substantially polarized light to be incident on a side surface of the crystal layer of the workpiece, the beam of light propagating substantially parallel to the X-Y plane at incidence;
b) rotating the workpiece about a rotation axis substantially parallel to the Z axis;
c) measuring a Raman shift of scattered light at each of a plurality of rotational positions during the rotation of the workpiece;
d) determining the crystalline orientation of the top crystal surface based on the plurality of Raman shifts measured in step (c); and
e) storing data indicating the determined crystalline orientation of the top crystal surface.

30. A method according to claim 29, wherein the beam of light is one of substantially linearly polarized or substantially circularly polarized.

31. A method according to claim 29, wherein step (c) includes the steps of:
c1) filtering the scattered light such that the filtered light has a narrow bandwidth corresponding to a predetermined Raman peak of the top crystal surface; and
c2) measuring a power of the filtered light at each of the plurality of angles of incidence to determine the corresponding Raman shift of the scattered light.

32. A method according to claim 29, further comprising the step of:
f) marking the workpiece consistent with the stored crystalline orientation data.

33. A method according to claim 29, further comprising the step of:
f) using the stored crystalline orientation data of the top crystal surface to determine a location of at least one cleavage plane through the workpiece; and
g) cleaving the workpiece along the at least one cleavage plane.

34. A method according to claim 29, further comprising the step of:
f) using the stored crystalline orientation data of the top crystal surface to determine a location of at least one dicing street on the top crystal surface; and
g) dicing the workpiece along the at least one dicing street.

35. A method according to claim 29, further comprising the step of:
f) using the stored crystalline orientation data of the top crystal surface to align at least one of:
a photolithographic mask to the top crystal surface;
a scan line of a laser writer on the top crystal surface;
a scan line of an e-beam writer on the top crystal surface; or
a tool path of a single-point micro-machining system on the top crystal surface.
